(19) United States
(12) Patent Application Publication
(10) Pub. No.: US 2023/0020072 A1
(43) Pub. Date: Jan. 19, 2023

(54) ZERO-VOLTAGE SWITCHING FOR BUCK-BOOST CONVERTER

(71) Applicant: Analog Devices, Inc., Wilmington, MA (US)

(72) Inventors: Jing Xue, San Jose, CA (US); Min Chen, Fremont, CA (US)

(21) Appl. No.: 17/379,750

(22) Filed: Jul. 19, 2021

(51) Int. Cl. H02M 1/00; H02M 3/158; H02M 1/08

(52) U.S. Cl. CPC H02M 1/0058; H02M 3/1582; H02M 1/083

(57) ABSTRACT

A zero-voltage switching (ZVS) buck-boost converter to reduce or even minimize switching power loss and improve EMI performance is described herein. The buck-boost converter may include an auxiliary path to generate an auxiliary current to charge and discharge respective nodes in the converter during select switching times. The converter may operate in buck-boost mode, buck mode, or boost mode. Moreover, the auxiliary path may include components, such as a pair of power switches and an inductor, arranged in a symmetrical fashion so that the converter may achieve ZVS in bidirectional operation as well.

### TECHNICAL FIELD

The present disclosure generally relates to buck-boost converters, in particular zero-voltage switching (ZVS) peak current mode 4-switch buck-boost converters.

### BACKGROUND

A buck-boost converter is a type of switched-mode power converter that can increase (e.g., boost), decrease (e.g., buck) or same as (e.g., buck-boost) an input voltage to a desired voltage suitable for different loads. These converters typically include a plurality of switches to control the power conversion. However, some buck-boost converters can suffer from large switching loss, leading to degraded performance.

### BRIEF DESCRIPTION OF THE DRAWINGS

Various ones of the appended drawings merely illustrate examples of the present disclosure and should not be considered as limiting its scope.

FIG. 1 is a circuit diagram of example portions of a power converter.

FIG. 2 illustrates examples of timing waveforms and operation states of the power converter operating in buck-boost mode.

FIG. 3 shows a graph of examples of minimum required peak auxiliary inductor current.

FIG. 4 illustrates examples of timing waveforms and operation states of the power converter operating in boost mode.

FIG. 5 illustrates examples of timing waveforms and operation states of the power converter operating in buck mode.

FIG. 6 is a circuit diagram of example portions of the power converter in bidirectional operation.

FIG. 7 illustrates examples of timing waveforms and operation states of the power converter operating in bidirectional operation.

### DETAILED DESCRIPTION

The present disclosure provides a zero-voltage switching (ZVS) buck-boost converter to reduce or even minimize switching power loss and improve electromagnetic interference (EMI) performance. The buck-boost converter may include an auxiliary path to generate an auxiliary current to charge and discharge select nodes in the converter during select switching times. The converter may operate in a selected mode amongst multiple modes, such modes including a buck-boost mode, buck mode, or boost mode, as illustrative examples. Moreover, the auxiliary path may include components, such as a pair of power switches and inductor, arranged in a symmetrical fashion so that the converter may achieve ZVS in bidirectional operation as well.

This document describes a power converter with switching power loss reduction. The power converter includes a first set of switches coupled together defining a first node, a second set of switches coupled together defining a second node, and a main inductor coupled to the first and second nodes. The power converter also includes an auxiliary path coupled to the first and second nodes, the auxiliary path including a set of auxiliary switches and an auxiliary inductor.

This document also describes a method to reduce switching power loss in a power converter. The method includes generating a main inductor current across a main inductor of the power converter, the main inductor coupled to a first and second node; generating an auxiliary inductor current across an auxiliary inductor of the power converter, the auxiliary inductor coupled to the first and second node; and during a switch transition of the power converter, charging the first node and discharging the second node with a difference of the auxiliary inductor current and the main inductor current.

This document further describes a buck-boost converter. The buck-boost converter includes a main stage with a first switch coupled to an input terminal and a first node, a second switch coupled to the first node, a third switch coupled to a second node, a fourth switch coupled to an output terminal and the second node, and a main inductor coupled to the first and second node. The buck-boost converter also includes an auxiliary path with a first auxiliary switch coupled to the first node, a second auxiliary switch coupled to the second node, and an auxiliary inductor coupled to the first and second auxiliary switches.

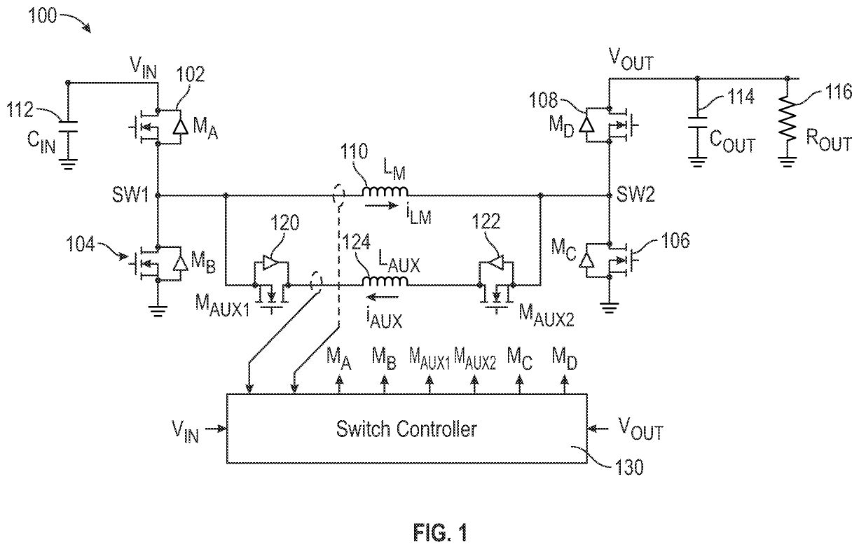

FIG. 1 illustrates a circuit diagram of example portions of a power converter 100. The power converter 100 may be provided as 4-switch buck-boost converter with an auxiliary path to reduce or even minimize switching loss. The power converter 100 may include switches M_{A}, M_{B}, M_{C}, M_{D} 102-108, a main inductor L_{M} 110, an input capacitor C_{IN} 112, an output capacitor C_{OUT} 114, a load R_{OUT} 116, a first auxiliary switch M_{AUX1} 120, a second auxiliary switch M_{AUX2} 122, an auxiliary inductor L_{AUX} 124, and a switch controller 130.

The switches M_{A}, M_{B}, M_{C}, M_{D} (102-108) and M_{AUX1}, M_{AUX2} (120, 122) may be provided as power switches, such as power field effect transistors (FETs). The body diode of each power switch is shown for operation analysis described in further detail below. The main power stage of the power converter 100 includes the main inductor L_{M} 110, the input and output capacitors C_{IN} 112, C_{OUT} 114, and the four power switches M_{A}, M_{B}, M_{C}, M_{D} (102-108). The first switch M_{A} 102 may be coupled to the input capacitor C_{IN} 112 providing an input voltage V_{IN} at one terminal of the first switch M_{A} 102. The first switch M_{A} 102 may also be coupled to the second switch M_{B} 104 and main inductor L_{M} 110 at node SW1. A first terminal of the main inductor L_{M} 110 may be coupled to node SW1. The second switch M_{B} 104 may also be coupled to ground.

The third switch M_{C} 106 may be coupled to the fourth switch M_{D} 108 and main inductor L_{M} 110 at node SW2. The third switch M_{C} 106 may also be coupled to the output capacitor C_{OUT} 114 providing an output voltage V_{OUT} at one terminal of the third switch M_{C} 106. The fourth switch M_{D} 108 may also be coupled to ground. And a second terminal of the main inductor L_{M} 110 may be coupled to node SW2. In this example, main inductor current (i_{LM}) may flow from node SW1 to node SW2 across the main inductor L_{M} 110. The labels V_{IN} and V_{OUT} are for illustration purposes only; as described in further detail below, the converter 100 may operate in bidirectional operations where V_{OUT} serves as the input voltage and V_{IN} serves as the output voltage in which case current i_{LM} may flow in the opposite direction.

The auxiliary path may include the two auxiliary switches M_{AUX1}, M_{AUX2} (120, 122) and the auxiliary inductor L_{AUX} 124 connected between nodes SW1 and SW2. The auxiliary inductor L_{AUX} 124 may be smaller than the main inductor L_{M} 110. An auxiliary inductor current i_{AUX} may flow in the opposite direction of the main inductor current i_{LM}, e.g., from SW2 to SW1.

The switch controller 130 may receive the input and output voltages V_{IN} and V_{OUT} and the main and auxiliary inductor currents (i_{LM}, i_{AUX}). The switch controller 130 may control the operation of the power switches M_{A}, M_{B}, M_{C}, M_{D} (102-108) and M_{AUX1}, M_{AUX2} (120, 122), as described in further detail below. For example, the switch controller 130 may control gate operation of the power switches.

An auxiliary inductor current i_{AUX} may be generated at the edges of switching transitions to charge node SW1 and discharge SW2 during deadtimes of the main stage. Hence, the four power switches M_{A}, M_{B}, M_{C}, M_{D} (102-108) of the main stage may achieve zero-voltage switching to reduce or even minimize the switching loss and improve EMI performance. The auxiliary power switches M_{AUX1}, M_{AUX2} (120, 122) may also achieve zero current switching (ZCS) during switching transition, which contributes to reducing or minimizing the switching loss as well. Hence, the power converter 100 may operate as ZVS peak current mode 4-switch buck-boost converter and may operate with minimum auxiliary inductor current to achieve ZVS, which can improve power efficiency.

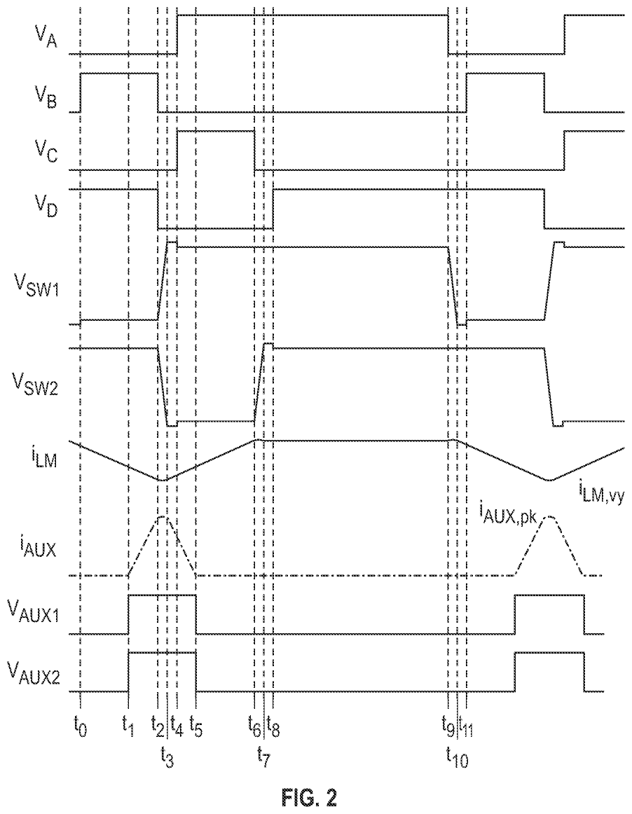

FIG. 2 illustrates examples of timing waveforms and operation states of the power converter 100 operating in buck-boost mode. V_{A}, V_{B}, V_{C}, V_{D} correspond to the voltages at power switches M_{A}, M_{B}, M_{C}, M_{D} (102-108) and thus indicate when those switches are on and off. Likewise, M_{AUX1}, M_{AUX2} correspond to the voltages at power switches M_{AUX1}, M_{AUX2} (120, 122) and thus indicate when those switches are on and off. V_{SW1} and V_{SW2} correspond to voltages at nodes SW1 and SW2, respectively.

At t₀, M_{D} is ON and M_{B} is turned ON. During this first subinterval (t₀-t₁), M_{A} and M_{C} are OFF. Thus, the voltage at SW1 and SW2 are 0 and V_{OUT}, respectively. The main inductor current i_{LM} is ramping down with the slope of −V_{OUT}/L_{M}. The auxiliary branch is disabled and the auxiliary inductor current i_{AUX} is 0.

At t₀, M_{AUX1} and M_{AUX2} are turned ON at zero-current condition. In this second subinterval (t₁-t₂), M_{A} to M_{D} keep the same state as the first subinterval (t₀-t₁). The voltage at SW1 and SW2 are still 0 and V_{OUT}, respectively. The main inductor current i_{LM} keeps ramping down with the slope of −V_{OUT}/L_{M}. The auxiliary inductor current i_{AUX} is ramping up from 0 with the slope of V_{OUT}/L_{AUX}. At the end of this interval, the current difference (i_{AUX}−i_{LM}) is greater than 0, so it can be used to charge SW1 and discharge SW2 in next time interval.

At t₂, M_{B} and M_{D} are turned OFF. In this third subinterval (t₂-t₃), M_{A} to M_{D} are OFF. The auxiliary branch is active and the current difference (i_{AUX}−i_{LM}) charges SW1 from 0 and discharge SW2 from V_{OUT} simultaneously. At the end of this time interval, SW1 is charged to V_{IN} and SW2 is discharged to 0.

During a fourth subinterval (t₃-t₄), M_{A} to M_{D} remain OFF. The auxiliary branch is still active and the current difference (i_{AUX}−i_{LM}) flows through the body diode of M_{A} and M_{C}. The voltage at SW1 is damped at V_{IN}+V_{FD} and the voltage at SW2 is damped at −V_{FD}. (V_{FD} is the forward voltage of body diode.) The zero-voltage switching conditions of M_{A} and M_{C} are established.

At t₄, M_{A} and M_{C} are turned ON under zero-voltage switching condition. The switching loss is minimized, and the EMI performance is improved. In this fifth subinterval (t₄-t₅), M_{A} and M_{C} are ON, M_{B} and M_{D} are OFF. The voltage at SW1 and SW2 are V_{IN} and 0, respectively. The main inductor current i_{LM} is ramping up with the slope of V_{IN}/L_{M}. The auxiliary branch is still active but the auxiliary inductor current i_{AUX} is ramping down with the slope of −V_{IN}/L_{AUX}. At t₅, the auxiliary current decreases to 0 and M_{AUX1} and M_{AUX2} are turned off. For example, a zero current comparator may be triggered by the auxiliary current decreasing to 0 to turn off M_{AUX1} and M_{AUX2}. The ZCS of M_{AUX1} and M_{AUX2} are achieved. The auxiliary branch is then disabled.

At t₅, the auxiliary branch is disabled. In this sixth subinterval (t₅-t₆), M_{A} to M_{D} keep the same state as subinterval 5 (M_{A} and M_{C} are ON, M_{B} and M_{D} are OFF). The voltage at SW1 and SW2 remain at V_{IN} and 0, respectively. The main inductor current i_{LM} keeps ramping up with the slope of V_{IN}/L_{M}. The auxiliary inductor current is 0.

At t6, M_{C} is turned OFF. In this seventh subinterval (t₆-t₇), M_{A} is ON, M_{B} to M_{D} are OFF. The voltage at SW1 remains at V_{IN} and the voltage at SW2 is charged by the main inductor current i_{LM}. At the end of this time interval, SW2 is charged to V_{OUT}.

In an eight subinterval (t₇-t₈) interval, M_{A} to M_{D} keep the same state as the seventh subinterval. The main inductor current i_{LM} flows through the body diode of M_{D} to the output. The voltage at SW1 is V_{IN} and the voltage at SW2 is damped at V_{OUT}+V_{FD}. The zero-voltage switching condition of M_{D} is established.

At t₈, M_{D} is turned ON under zero-voltage switching condition. In this ninth subinterval (t₈-t₉), M_{A} and M_{D} are ON, and M_{B} and M_{C} are OFF. The voltage at SW1 and SW2 are V_{IN} and V_{OUT}, respectively. The main inductor current i_{LM} flows from V_{IN} to V_{OUT} with the slope of (V_{IN}−V_{OUT})/L_{M}. (The main inductor current i_{LM} is ramping up if V_{IN} is higher than V_{OUT}; the main inductor current i_{LM} is ramping down if V_{IN} is less than V_{OUT}.)

At t₄, M_{A} is turned OFF. In this tenth subinterval (t₉-t₁₀), M_{A}, M_{B}, and M_{C} are OFF, and M_{D} is ON. The voltage at SW1 is discharged by the main inductor current i_{LM} and the voltage at SW2 is V_{OUT}. At the end of this time interval, SW1 is discharged to 0.

In the eleventh subinterval (t₁₀-t₁₁), M_{A} to M_{D} keep the same state as the tenth subinterval. The main inductor current i_{LM} flows through the body diode of M_{B}. The voltage at SW1 is clamped at −V_{FD} and the voltage at SW2 is V_{OUT}. The zero-voltage switching condition of M_{B} is established. At t11, M_{B} is turned ON with zero-voltage switching. The operation of the whole switching period may end, and the sequence may repeat from subinterval 1 to 11.

As described above, an AC-AD-BD (i.e., M_{A} and M_{C} are ON—M_{A} and M_{D} are ON—M_{B} and M_{D} are ON) operation of the buck-boost converter may be used (e.g., starting at the fifth subinterval at t₅). Embodiments of the converter disclosed herein may ensure maximum energy transferred the output by including AD phase (e.g., ninth subinterval). The larger AD phase, the more energy can be transferred from V_{IN} to V_{OUT} directly. If V_{IN} is less than V_{OUT}, the BD phase is fixed and its duty ratio is α. If V_{IN} is higher than V_{OUT}, the AC phase is fixed and its duty ratio is α. The average main inductor current I_{LM, avg} is:

$${I}_{LM , avg} = \frac{{I}_{O U T} \times {V}_{OUT}}{{V}_{IN} \times ( 1 - α )} \approx {i}_{LM , vy} , when {V}_{IN} < {V}_{OUT} \\ {I}_{LM , avg} = \frac{{I}_{O U T}}{( 1 - α )} \approx {i}_{LM , vy} , when {V}_{i n} < {V}_{out}$$

Therefore, the minimum required peak auxiliary inductor current i_{AUX, pk} is:

$${I}_{AUX , p k} = \frac{{I}_{O U T} \times {V}_{OUT}}{{V}_{IN} \times ( 1 - α )} , when {V}_{IN} < {V}_{OUT} \\ {I}_{AUX , p k} = \frac{{I}_{O U T}}{( 1 - α )} , when {V}_{i n} < {V}_{out}$$

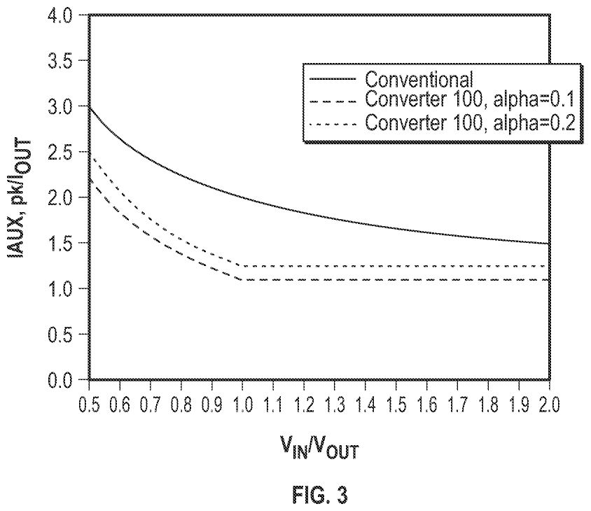

FIG. 3 shows a comparison of minimum required peak auxiliary inductor current between conventional AC-BD operation and AC-AD-BD operation disclosed herein. The V_{IN}/V_{OUT} is between 0.5 and 2.0. As can be seen, the minimum required current is much smaller in the converter disclosed herein, which result in less conduction loss in the proposed converter.

The timing of turning-ON (t₁ in FIG. 2) and turning-OFF (t₅ in FIG. 2) M_{AUX1} and M_{AUX2} enable to ZVS of converter 100. The auxiliary inductor current i_{AUX} increases from 0 to i_{AUX, pk} with the slope of V_{OUT}/L_{AUX} during subinterval 2. The auxiliary inductor current is thus high enough to charge SW1 and discharge SW2. The time duration Δt between t₁ and t₂ is given by:

$$Δ t = {t}_{2} - {t}_{1} = \frac{{i}_{A U X , p k} \times {L}_{AUX}}{{V}_{OUT}}$$

Since t₂ may be determined by a system clock, t₁ is then determined by the preset time Δt before t₂.

On the other hand, the turning-OFF of M_{AUX1} and M_{AUX2} may be determined by the zero current of auxiliary inductor current i_{AUX}. For example, a zero-current comparator may be used to monitor the auxiliary inductor current. Once the auxiliary inductor current i_{AUX} is decreased to 0, the comparator is triggered and M_{AUX1} and M_{AUX2} are turned OFF to disable the auxiliary branch.

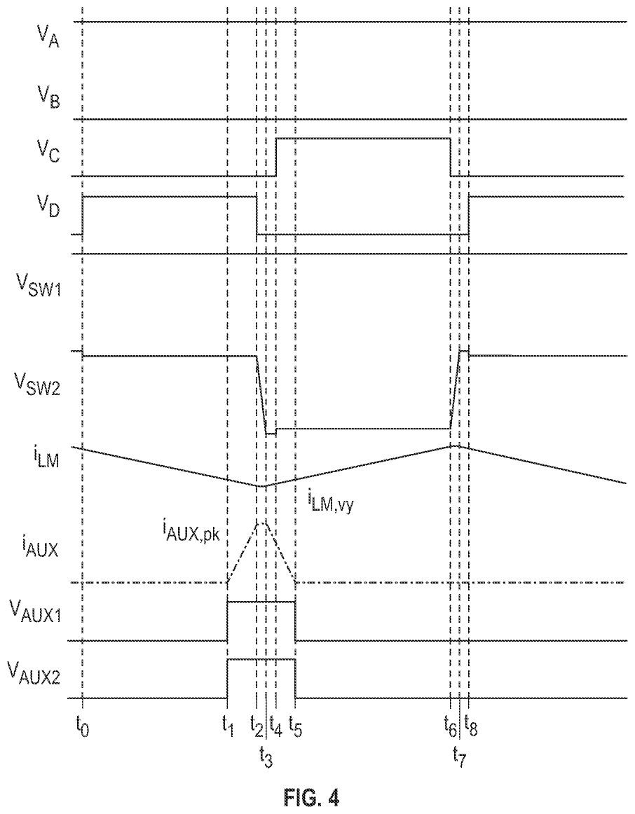

Power converter 100 can operate in boost-only and buck-only operation. FIG. 4 illustrates examples of timing waveforms and operation states of the converter 100 operating in boost mode. Here, M_{A} is always ON, and M_{B} is always OFF. The voltage at node SW1 is always at V_{IN}. Thus, the auxiliary path is used for the switching between M_{C} and M_{D} and the converter 100 operates in a 2-switch ZVS boost operation.

At to, M_{C} is OFF and M_{D} is turned ON. During this first subinterval (t₀-t₁), M_{C} is OFF and M_{D} is ON. The main inductor current it-N is ramping down with the slope of −V_{OUT}/L_{M}. The auxiliary branch is disabled and the auxiliary inductor current i_{AUX} is 0.

At t₁, M_{AUX1} and M_{AUX2} are turned ON at zero-current condition. In this second subinterval (t₁-t₂), M_{C} and M_{D} keep the same state as the first subinterval (t₀-t₁). The voltage at SW1 and SW2 are still V_{IN} and V_{OUT}, respectively. The main inductor current i_{LM} keeps ramping down with the slope of −V_{OUT}/L_{M}. The auxiliary inductor current i_{AUX} is ramping up from 0 with the slope of V_{OUT}/L_{AUX}.

At t₂, M_{D} is turned OFF. In this third subinterval (t₂-t₃), M_{C} and M_{D} are OFF. The auxiliary branch is active and the current difference (i_{AUX}−i_{LM}) discharge SW2. At the end of this time interval, SW2 is discharged to 0.

During a fourth subinterval (t₃-t₄), M_{C} and M_{D} remain OFF. The auxiliary branch is still active and the current difference (i_{AUX}−i_{LM}) flows through the body diode of M_{C}.

At t₄, M_{C} is turned ON under zero-voltage switching condition. The switching loss is minimized, and the EMI performance is improved. In this fifth subinterval (t₄-t₅), M_{C} is ON, M_{D} is OFF. The voltage at SW2 is 0. The main inductor current i_{LM} is ramping up with the slope of V_{IN}/L_{M}. The auxiliary branch is still active but the auxiliary inductor current i_{AUX} is ramping down with the slope of −V_{IN}/L_{AUX}. At t₅, the auxiliary current decreases to 0 and M_{AUX1} and M_{AUX2} are turned off. For example, a zero current comparator may be triggered by the auxiliary current decreasing to 0 to turn off _{MAUX1} and M_{AUX2}. The ZCS of M_{AUX1} and M_{AUX2} are achieved. The auxiliary branch is then disabled.

At t₅, the auxiliary branch is disabled. In this sixth subinterval (t₅-t₆), M_{C} and M_{D} keep the same state as subinterval 5 (M_{C} is ON, M_{D} is OFF). The voltage at SW1 and SW2 remain at V_{IN} and 0, respectively. The main inductor current i_{LM} keeps ramping up with the slope of V_{IN}/L_{M}. The auxiliary inductor current is 0.

At t₆, M_{C} is turned OFF. In this seventh subinterval (t₆-t₇), M_{C} and M_{D} are OFF. The voltage at SW1 remains at V_{IN} and the voltage at SW2 is charged by the main inductor current i_{LM}. At the end of this time interval, SW2 is charged to V_{OUT}.

In an eight subinterval (t₇-t₈) interval, M_{C} and M_{D} keep the same state as the seventh subinterval. The main inductor current i_{LM} flows through the body diode of M_{D} to the output. The voltage at SW1 is V_{IN} and the voltage at SW2 is clamped at V_{OUT}+V_{FD}. The zero-voltage switching condition of M_{D} is established.

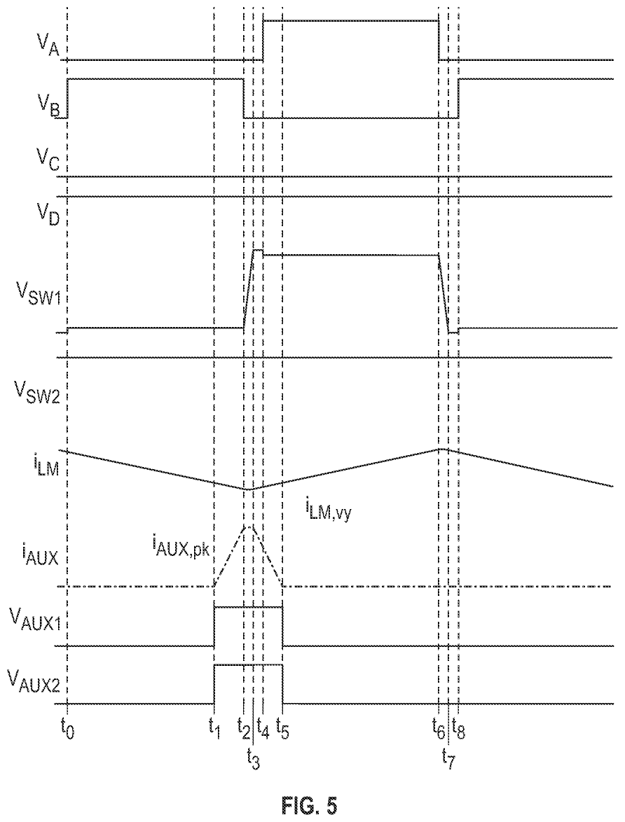

FIG. 5 illustrates examples of timing waveforms and operation states of the converter 100 operating in buck mode. Here, M_{D} is always ON, and M_{C} is always OFF. The voltage at node SW2 is always at V_{OUT}. Thus, the auxiliary path is used for the switching between M_{A} and M_{B}, and the converter 100 operates in a 2-switch ZVS buck operation.

At t₀, M_{A} is OFF and M_{B} is turned ON. During this first subinterval (t₀-t₁), M_{A} and M_{C} are OFF. During this first subinterval (t₀-t₁), M_{A} is OFF and M_{B} is ON. The main inductor current i_{LM} is ramping down with the slope of −V_{OUT}/L_{M}. The auxiliary branch is disabled and the auxiliary inductor current i_{AUX} is 0.

At t₁, M_{AUX1} and MA_{UX2} are turned ON at zero-current condition. In this second subinterval (t₁-t₂), M_{A} and M_{B} keep the same state as the first subinterval (t₀-t₁). The voltage at SW1 and SW2 are still 0 and V_{OUT}, respectively. The main inductor current i_{LM} keeps ramping down with the slope of −V_{OUT}/L_{M}. The auxiliary inductor current i_{AUX} is ramping up from 0 with the slope of V_{OUT}/L_{AUX}.

At t₂, M_{B} is turned OFF. In this third subinterval (t₂-t₃), M_{A} and M_{B} are OFF. The auxiliary branch is active and the current difference (i_{AUX}−i_{LM}) discharge SW2. At the end of this time interval, SW1 is charged to V_{IN}.

During a fourth subinterval (t₃-t₄), M_{A} and M_{B} remain OFF. The auxiliary branch is still active and the current difference (i_{AUX}−i_{LM}) flows through the body diode of M_{A}.

At t₄, M_{A} is turned ON under zero-voltage switching condition. The switching loss is minimized, and the EMI performance is improved. In this fifth subinterval (t₄-t₅), M_{A} is ON, M_{B} is OFF. The voltage at SW1 is V_{IN}. The main inductor current i_{LM} is ramping up with the slope of V_{IN}/L_{M}. The auxiliary branch is still active but the auxiliary inductor current i_{AUX} is ramping down with the slope of −V_{IN}/L_{AUX}. At t₅, the auxiliary current decreases to 0 and M_{AUX1} and M_{AUX2} are turned OFF. For example, a zero current comparator may be triggered by the auxiliary current decreasing to 0 to turn off M_{AUX1} and M_{AUX2}. The ZCS of M_{AUX1} and M_{AUX2} are achieved. The auxiliary branch is then disabled.

At t₅, the auxiliary branch is disabled. In this sixth subinterval (t₅-t₆), M_{A} and M_{B} keep the same state as subinterval 5 (M_{A} is ON, M_{B} is OFF). The voltage at SW1 and SW2 remain at V_{IN} and V_{OUT}, respectively. The main inductor current i_{LM} keeps ramping up with the slope of V_{IN}/L_{M}. The auxiliary inductor current is 0.

At t₆, M_{A} is turned OFF. In this seventh subinterval (t₆-t₇), M_{A} and M_{B} are OFF. The voltage at SW1 is discharged. At the end of this time interval, SW2 is discharged to 0.

In an eight subinterval (t₇-t₈) interval, M_{A} and M_{B} keep the same state as the seventh subinterval. The main inductor current i_{LM} flows through the body diode of M_{B} to the output. The zero-voltage switching condition of M_{D} is established.

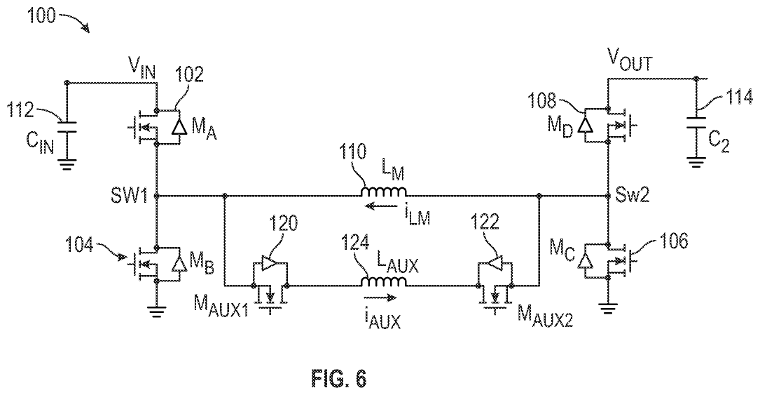

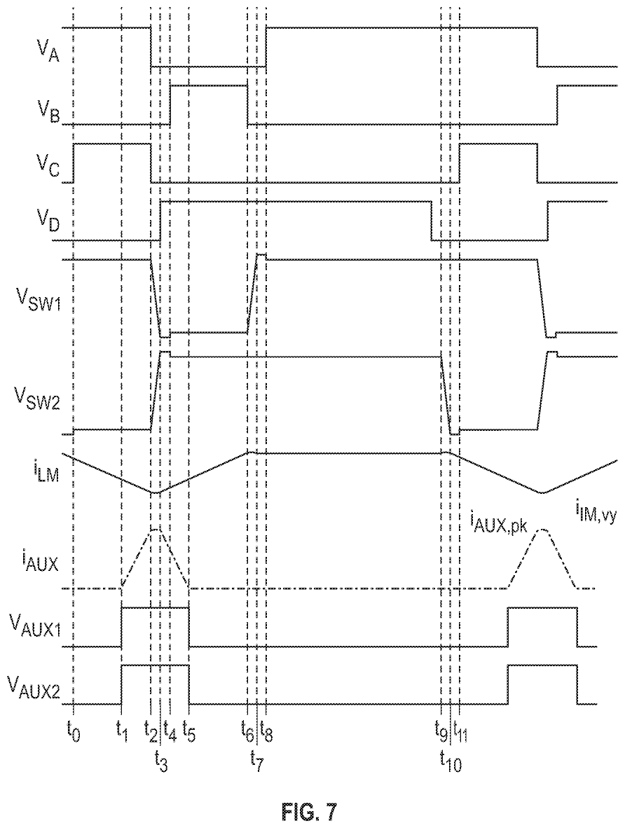

Moreover, the converter 100 may be used in bi-directional applications. For example, the converter 100 may be used in a dual-battery system such as an electric vehicle. Bi-directional mode may be used when power goes from a backup battery to the main battery. In bi-directional, current can also from V_{OUT} to V_{IN}. When the current flows from V_{OUT} to V_{IN}, the hard switching happens during M_{B} and M_{D} turning ON. The symmetrical implementation of M_{AUX1} and M_{AUX2} allows the converter 100 to achieve ZVS in bidirectional operation as well. FIG. 6 illustrates a circuit diagram of example portions of the power converter 100 operating in bidirectional operation. FIG. 7 illustrates examples of timing waveforms and operation states of the power converter 100 operating in bidirectional operation. The timing waveforms of FIG. 7 are inverted as compared to the timing waveforms of FIG. 2 to operate in bidirectional mode because the main inductor current now flows from SW2 to SW1 and the auxiliary inductor current now flows from SW1 and SW2.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “Abut not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled.

What is claimed is:

1. A power converter with switching power loss reduction, the power converter comprising:
a first set of switches coupled together defining a first node;
a second set of switches coupled together defining a second node;
a main inductor coupled to the first and second nodes; and
an auxiliary path coupled to the first and second nodes, the auxiliary path including a set of auxiliary switches and an auxiliary inductor.

2. The power converter of claim 1, further comprising:
a controller to control operations of the first and second set of switches and the set of auxiliary switches.

3. The power converter of claim 1, wherein the auxiliary path to generate an auxiliary inductor current across the auxiliary inductor during a switch transition of the first and second set of switches.

4. The power converter of claim 3, wherein the auxiliary inductor current to charge the first node and discharge the second node during the switch transition.

5. The power converter of claim 1, wherein power converter is configured to operate in buck-boost mode, buck mode, or boost mode.

6. The power converter of claim 1, wherein the power converter is configured to operate in bidirectional operation.

7. The power converter of claim 1, the main inductor has an inductance that is larger in magnitude than a corresponding inductance of the auxiliary inductor.

8. The power converter of claim 1, further comprising:
a comparator to detect the auxiliary inductor reaching a threshold value;
wherein the auxiliary path is configured to be disabled based on detecting the auxiliary inductor reaching the threshold value.

9. A method to reduce switching power loss in a power converter, comprising:
generating a main inductor current across a main inductor of the power converter, the main inductor coupled to a first and second node;
generating an auxiliary inductor current across an auxiliary inductor of the power converter, the auxiliary inductor coupled to the first and second node; and
during a switch transition of the power converter, charging the first node and discharging the second node with a difference of the auxiliary inductor current and the main inductor current.

10. The method of claim 9, wherein the power converter operates in one of a buck-boost mode, a buck mode, or a boost mode.

11. The method of claim 9, wherein the auxiliary inductor current is generated using a set of auxiliary switches coupled to the auxiliary inductor.

12. The method of claim 9, further comprising:
detecting the auxiliary inductor reaching a threshold value;
disabling generation of the auxiliary inductor based on detecting the auxiliary inductor current reaching the threshold value.

13. The method of claim 9, wherein the power converter configured to operate in bidirectional operation.

14. The method of claim 9, wherein the main inductor has an inductance that is larger in magnitude than a corresponding inductance of the auxiliary inductor.

15. A buck-boost converter, comprising:
a main stage comprising:
a first switch coupled to an input terminal and a first node;
a second switch coupled to the first node;
a third switch coupled to a second node;
a fourth switch coupled to an output terminal and the second node; and
a main inductor coupled to the first and second node; and
an auxiliary path comprising:
a first auxiliary switch coupled to the first node;
a second auxiliary switch coupled to the second node; and
an auxiliary inductor coupled to the first and second auxiliary switches.

16. The buck-boost converter of claim 15, further comprising:
a controller to turn on the first and second auxiliary switches during a switch transition of the main stage.

17. The buck-boost converter of claim 16, wherein the controller to turn off the first and second auxiliary switches based on an auxiliary inductor current reaching a threshold value.

18. The buck-boost converter of claim 15, wherein the buck-boost converter is configured to operate in buck-boost mode, buck mode, or boost mode.

19. The buck-boost converter of claim 15, wherein the buck-boost converter is configured to operate in bidirectional operation.

20. The buck-boost converter of claim 15, the main inductor has an inductance that is larger in magnitude than a corresponding inductance of the auxiliary inductor.
